(19) United States
(12) Patent Application Publication
(10) Pub. No.: US 2015/0227886 A1
(43) Pub. Date: Aug. 13, 2015

(54) REVERSE LOGISTICS SHIPPING SYSTEM AND METHOD FOR PASSIVE THERMAL CONTROL SHIPPING CONTAINERS

(71) Applicant: MINNESOTA THERMAL SCIENCE, LLC, Plymouth, MN (US)

(72) Inventor: Richard C. Peters, Woodbury, MN (US)

(21) Appl. No.: 14/430,681

(22) PCT Filed: Sep. 25, 2013
(86) PCT No.: PCT/US13/61661

§ 371 Date: Mar. 24, 2015

Related U.S. Application Data
(60) Provisional application No. 61/705,382, filed on Sep. 25, 2012.

(51) Int. Cl. G06Q 10/08

(52) U.S. Cl. CPC G06Q 10/0832

(57) ABSTRACT

A reverse logistics shipping system 10 for passive thermal control shipping containers 20 that require thermal conditioning at a management facility 100 prior to each use of the container 20 to deliver a thermally labile payload 30 from a distribution facility 200 to a customer facility 300.

This application claims the benefit of U.S. Provisional Application No. 61/705,382, filed Sep. 25, 2012.

### BACKGROUND

A wide variety of goods are thermally labile and therefore need to be maintained above and/or below a target temperature at all times to prevent spoilage, decomposition, deactivation, transformation, conversion, breakdown, etc. Exemplary thermally labile goods include blood, blood products such as red blood cells (RCBs) and blood platelets, transplantable organs, biological tissue, vaccines, antigens, antibodies, bacteriological samples, immunoassays, pharmaceuticals, enzymes, and single-use chromogenic thermometers.

Thermally insulted shipping containers are widely used to transport thermally labile goods from a manufacturing or distribution facility, such as a blood collection center, to the end user, such as a hospital. Numerous insulated shipping containers have been developed over the years, with those deploying a phase change material generally providing superior temperature control over extended periods. A nonexhaustive list of United States Patents and Published Patent Applications disclosing insulated shipping containers employing a phase change material, hereinafter referenced as passive thermal control shipping containers or simply shipping containers, include U.S. Pat. Nos. 4,145,895; 4,579,170; 4,923,077; 4,931,333; 5,626,936; 5,899,088; 6,209,343; 6,718,776; 7,257,963; 7,422,143; 7,500,593 and 8,424,335, and United States Patent Application Publications 2002/0050147; 2005/0188714, and 2011/0248038, 2013/0228583.

Quality shipping containers capable of reliably maintaining a payload within a narrow thermal window over an extended period of time are generally desired by manufacturing and distribution facilities that ship thermally labile goods, as they greatly increase customer satisfaction and reduce shrinkage by consistently and reliably maintaining thermal integrity during transport. However, the high cost of quality shipping containers has limited the use of quality shipping containers.

Accordingly, a substantial need exists for a reverse logistics system and method for securing return of spent passive thermal control shipping containers from end users. The system and method preferably requires little or no participation by the end user (i.e., the customer who purchased the thermally labile payload—not the shipping container) as they are generally interested only disposing of the container in the most efficient and inexpensive manner, and have little incentive to expend time, money and resources to secure a return of the shipping container to its source.

### SUMMARY OF THE INVENTION

A first aspect of the invention is a delivery and recovery shipping logistics system for passive thermal control shipping containers that require thermal conditioning at a management facility prior to each use of the container to deliver a thermally labile payload from a distribution facility to a customer facility. The system includes at least (i) a computer network server operable for communicating with at least one distribution facility computer, and at least one courier computer, and (ii) a common database of the computer network server operable for storing information relating to each of a plurality of shipping containers. The system is programmed and operable for (A) capture of inventory data indicating inventory of shipping containers managed by the management facility and a unique identifier applied to each shipping container in inventory, (B) capture of shipment and location data for each shipping container, correlated to the unique identifier of each shipping container, that includes at least (−) an identification of the most recent delivery destination of the shipping container as between the management facility, an identified distribution facility, and an identified customer facility, and (−) at least one of sent date, delivered date and receipt date of the shipping container at the most recent delivery destination, and (C) generating a report including at least one action statistic derived at least in part from the captured shipment and location data for the shipping containers in inventory.

The system is preferably operable for communicating with a plurality of distribution facility computers located at different distribution facilities, and a plurality of different courier computers.

The action statistic contained in the report is preferably one or more of (i) a low inventory signal, triggered by a number of shipping containers in inventory below a threshold value, (ii) an expired container signal, triggered by a thermally conditioned shipping container located at a distribution facility for longer than a threshold time period without use of the shipping container to deliver a payload, (iii) a forgotten container signal, triggered by a shipping container located at a customer facility for longer than a threshold time period, and (iv) a stockpile signal, triggered by a number of shipping containers located at a customer facility in excess of a given threshold value.

A second aspect of the invention is a method for managing delivery and recovery of passive thermal control shipping containers that require thermal conditioning at a management facility prior to each use of the container to deliver a thermally labile payload from a distribution facility to a customer facility, employing a system according to the first aspect of the invention.

A first embodiment of the second aspect of the invention includes the steps of (i) inputting inventory data for shipping containers managed by an integrated management and distribution facility into the electronic memory, (ii) preparing a deliverable container at the integrated management and distribution facility that includes (A) applying a return label bearing a tracking number and a receiving address for the integrated facility to shipping containers, (B) inputting the tracking number from each return label into the electronic memory, correlated to the unique identifier of the shipping container to which the return label is applied, and (C) placing a thermally labile payload into and applying a delivery label onto shipping containers at the integrated facility, wherein the delivery label identifies a receiving address for a customer facility to which the payload is to be delivered, (iii) inputting the tracking number and receiving address from each delivery label into the electronic memory, correlated to the unique identifier of the shipping container to which the delivery label is applied, (iv) shipping each of the deliverable containers to the customer facility identified on the delivery label, (v) inputting at least one of sent date, delivered date and receipt date for each shipped container into the electronic memory, correlated to the unique identifier of the shipped shipping container, (vi) unloading the thermally labile payload from each shipped container at each customer facility to form empty containers, (vii) transporting the empty containers back to the integrated facility employing the return label previously applied to the shipping container, and (viii) inputting at least one of sent date, delivered date and receipt date for each transported container into the electronic memory, correlated to the unique identifier of the transported shipping container.

A second embodiment of the second aspect of the invention includes the steps of (i) inputting inventory data for shipping containers managed by a management facility into the electronic memory, (ii) applying a transfer label identifying a distribution facility, and a return label bearing a tracking number and a receiving address for a management facility, to shipping containers at the management facility to create labeled containers, (iii) inputting the tracking number and receiving address from each transfer label, and tracking number from each return label, into the electronic memory, correlated to the unique identifier of the shipping container to which the transfer label and return label are applied, (iv) transferring each labeled container to the distribution facility identified on the transfer label, (v) inputting at least one of sent date, delivered date and receipt date for each transferred container into the electronic memory, correlated to the unique identifier of the transferred shipping container, (vi) preparing a deliverable container at the distribution facility, comprising the steps of placing a thermally labile payload into and applying a delivery label onto transferred shipping containers at the integrated facility, wherein the delivery label identifies a receiving address for a customer facility to which the payload is to be delivered, (vii) inputting the tracking number and receiving address from each delivery label into the electronic memory, correlated to the unique identifier of the shipping container to which the delivery label is applied, (viii) shipping each of the deliverable containers to the customer facility identified on the delivery label, (ix) inputting at least one of sent date, delivered date and receipt date for each shipped container into the electronic memory, correlated to the unique identifier of the shipped shipping container, (x) unloading the thermally labile payload from each shipped container at each customer facility to form empty containers, (xi) transporting the empty containers back to the management facility identified on the return label, employing the return label previously applied to the shipping container, and (xii) inputting at least one of sent date, delivered date and receipt date for each transported container into the electronic memory, correlated to the unique identifier of the transported shipping container.

### BRIEF DESCRIPTION OF THE DRAWINGS

FIG. 1 is an assembly drawing for an exemplary passive thermal control shipping container suitable for use in the present invention.

FIG. 2 is an isometric view of the shipping container depicted in FIG. 1 prepared for transfer from a management facility to a distribution facility.

FIG. 3 is an isometric view of the shipping container depicted in FIG. 2 loaded and prepared for shipment from a distribution facility to a customer facility.

FIG. 4 is an isometric view of the shipping container depicted in FIG. 3 after removal of the payload at a customer facility.

FIG. 5 is an isometric view of the shipping container depicted in FIG. 4 prepared for transport from a customer facility to a management facility.

FIG. 6 is a schematic flow diagram depicting shipping container movement in one embodiment of the invention in which a single management facility coordinates and manages shipping container trips through a plurality of delivery and recovery loops, including a management-distribution-customer loop, a management-distribution-dual customer loop, and an integrated management and distribution-customer loop.

FIG. 7 is an enlarged schematic flow diagram for the management-distribution-customer loop depicted in FIG. 6, including a generic depiction of electronic communication links with the computer network server.

FIG. 8 is a schematic flow diagram depicting input and capture of data for each trip of each shipping container through the management-distribution-customer loop depicted in FIG. 7, wherein all such data is correlated directly or indirectly to the unique identifier of the shipping container moving through the loop.

### DETAILED DESCRIPTION OF A PREFERRED EMBODIMENT

### Definitions

As used herein, including the claims, the phrase “action statistic” means the value of a measured or calculated variable suggestive of the need for remedial or corrective action designed to favorably change or adjust the measured or calculated variable.

As used herein, including the claims, the phrase “sent date” means a date, input by either a facility sending a parcel or a carrier receiving a parcel for delivery, as the date the delivering carrier took possession of the parcel.

As used herein, including the claims, the phrase “delivered date” means a date input by a carrier as the date a parcel was delivered to a facility.

As used herein, including the claims, the phrase “receipt date” means a date input by a facility receiving a parcel as the date the parcel was received by the facility.

As used herein, including the claims, the phrase “management facility” means a facility staffed and equipped to (i) thermally condition PCM panels, (ii) assemble passive thermal control shipping containers with thermally conditioned PCM panels, (iii) coordinate transport of assembled shipping containers to at least one distribution facility, and (iv) receive empty, thermally spent passive thermal control shipping containers for inspection, cleaning, refurbishment, repair, replacement and/or disposal of the shipping container components (i.e., outer structural shell, thermal insulation panels, PCM panels, etc.), for subsequent thermal reconditioning and reuse of some or all of the shipping container components.

As used herein, including the claims, the phrase “distribution facility” means a facility staffed and equipped to (i) load a thermally labile payload into thermally conditioned passive thermal control shipping containers, and (ii) coordinate transport of loaded shipping containers to at least one customer facility (e.g., a blood bank or a pharmaceutical distribution center).

As used herein, including the claims, the phrase “customer facility” means a facility that purchases thermally labile goods for use (e.g., a hospital), or for supply to an individual end-user of the goods (e.g., a pharmacy).

As used herein, including the claims, the term “transfer label” means a label indicating the address of a destination distribution facility and a unique tracking number employed by a third party carrier to identify the shipping container.

As used herein, including the claims, the term “delivery label” means a label indicating the address of a destination customer facility and a unique tracking number employed by a third party carrier to identify the shipping container.

As used herein, including the claims, the term “return label” means a label indicating the address of a destination management facility and a unique tracking number employed by a third party carrier to identify the shipping container.

As used herein, including the claims, the term “tracking number” means a unique number assigned to a parcel by a shipping service to trace current location and delivery status of the parcel.

As used herein, including the claims, the term “trip”, when used in connection with a shipping container or shipping container components, means a round trip shipment out from and back to a management facility with the expectation that the shipping container will be used to ship a payload placed within the shipping container.

### NOMENCLATURE TABLE

10 Logistics System

20 Shipping Container

20ₐ Thermally Conditioned Shipping Container

20_{b} Loaded Shipping Container

20_{c} Empty Shipping Container

21 Outer Structural Shell

22 Thermal Insulation Panels

23 Phase Change Material Panels (PCM Panels)

24 Shipping Container Identification No. Label

25ₐ Transfer Label

25_{b} Delivery Label

25_{c} Return Label

29 Retention Chamber

30 Payload

90 Computer Network Server

100 Management Facility

110 Management Facility Computer

150 Transfer Courier

150 Transfer Courier for Delivery and Recovery Loop n

160 Transfer Courier Computer

200 Distribution Facility

200ₙ Distribution Facility in Delivery and Recovery Loop n

210 Distribution Facility Computer

250 Delivery Courier

250ₙ Delivery Courier for Delivery and Recovery Loop n

260 Delivery Courier Computer

300 Customer Facility

300ₙ Customer Facility in Delivery and Recovery Loop n

300ₙₐ First Customer Facility in Delivery and Recovery Loop n

300_{nb} Second Customer Facility in Delivery and Recovery Loop n

310 Customer Facility Computer

350 Return Courier

350ₙ Return Courier for Delivery and Recovery Loop n

360 Return Courier Computer

α Delivery and Recovery Loop wherein n=1

β Delivery and Recovery Loop wherein n=2

γ Delivery and Recovery Loop wherein n=3

### Description

The invention is directed to a logistics system 10 and method for delivery and recovery of passive thermal control shipping containers 20 used in the delivery of thermally labile payloads 30.

### Passive Thermal Control Shipping Container 20

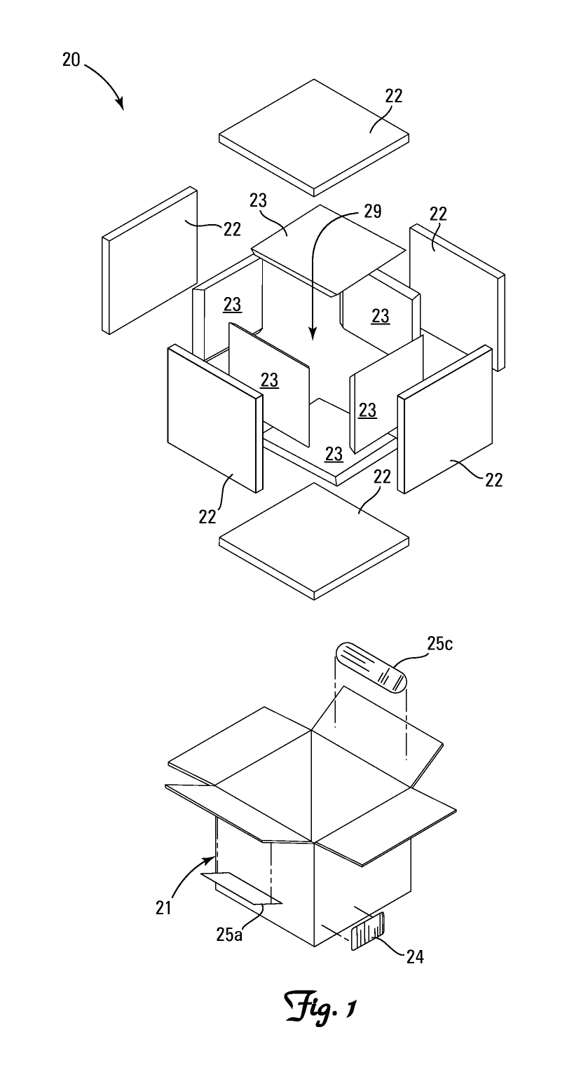

Referring generally to FIG. 1, passive thermal control shipping containers 20 suitable for use in the present invention include an outer structural shell 21, thermal insulation 22 and PCM panels 23. These components may be provided as separate and independent components or may be combined into integrated units (e.g., an outer structural shell 21 filled with thermal insulation 22, a panel of thermal insulation 22 adhesively attached to a PCM panel 23, etc.). Substantially any passive thermal control shipping container 20 can be employed in the present invention, including those disclosed in U.S. Pat. Nos. 4,145,895; 4,579,170; 4,923,077; 4,931,333; 5,626,936; 5,899,088; 6,209,343; 6,718,776; 7,257,963; 7,422,143; 7,500,593 and 8,424,335, and United States Patent Application Publications 2002/0050147; 2005/0188714, and 2011/0248038, 2013/0228583, the disclosures of which are hereby incorporated by reference.

Referring to FIGS. 1-5, each shipping container 20 used in the present logistics system 10 bears a unique identification number 24. The container ID number 24 is preferably a machine readable code, such as a bar code, adhesively applied to the exterior surface of the outer structural shell 21 to facilitate scanning of the label prior to each trip.

### Physical Trips

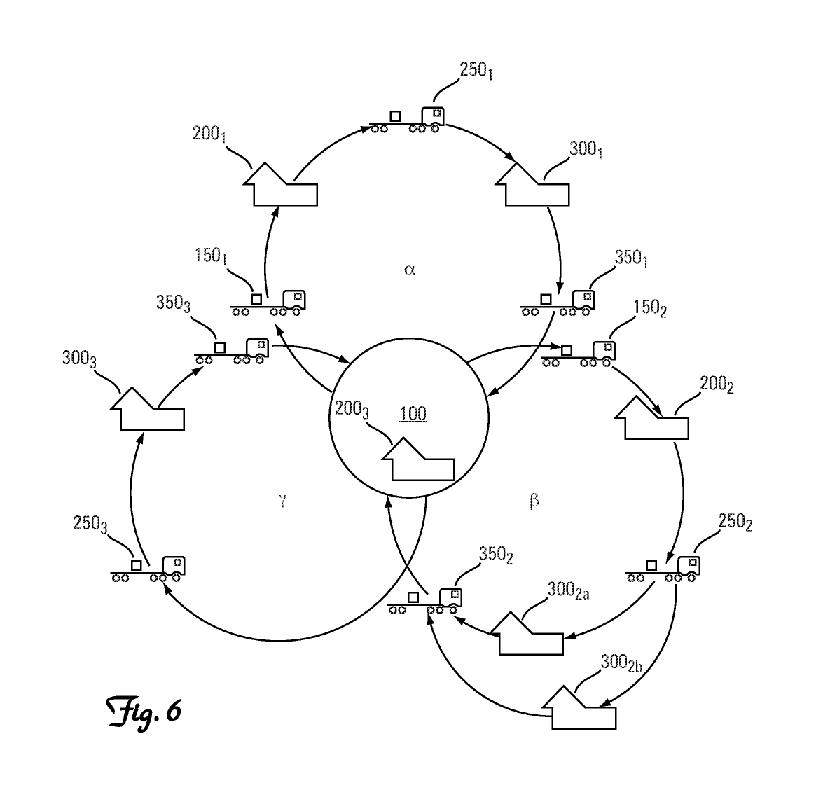

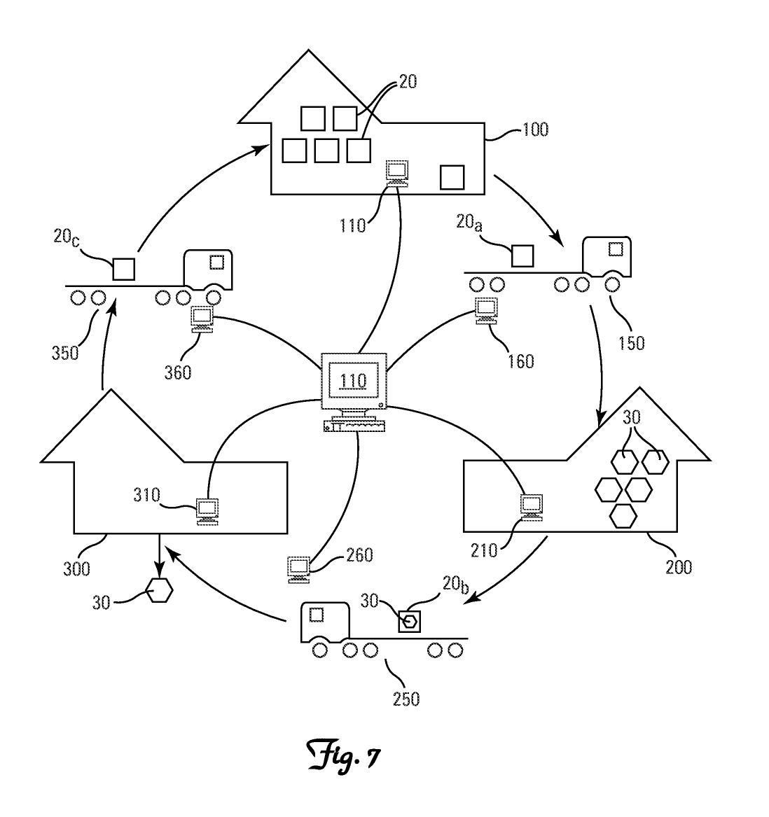

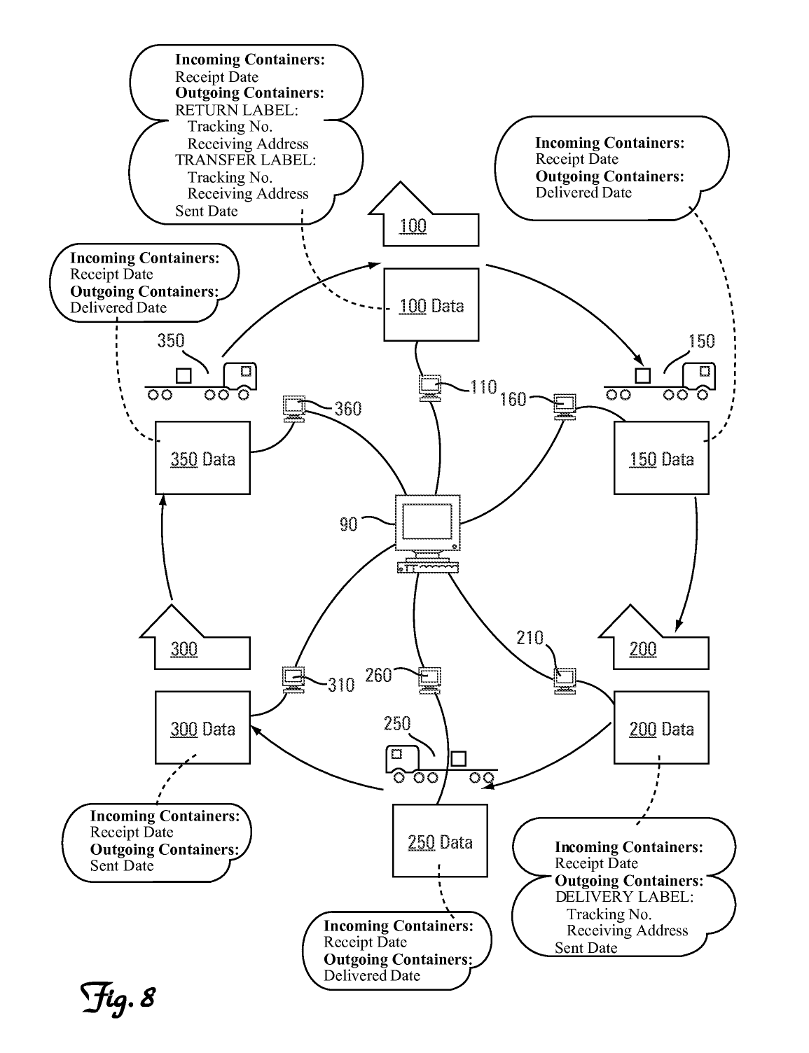

Referring generally to FIG. 6, shipping containers 20, each bearing a unique identification number 24, travel through delivery and recovery loops (i.e., trips) that include at least one management facility 100, at least one distribution facility 200, and at least one customer facility 300. Movement of the shipping containers 20 between facilities can be accomplished by utilizing the services of an existing third party courier such as DHL, FedEx, UPS, USPS, etc.

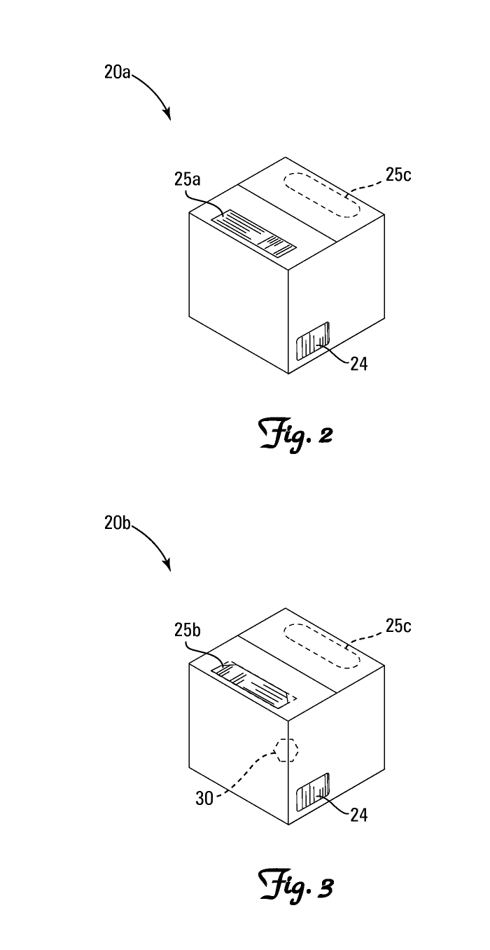

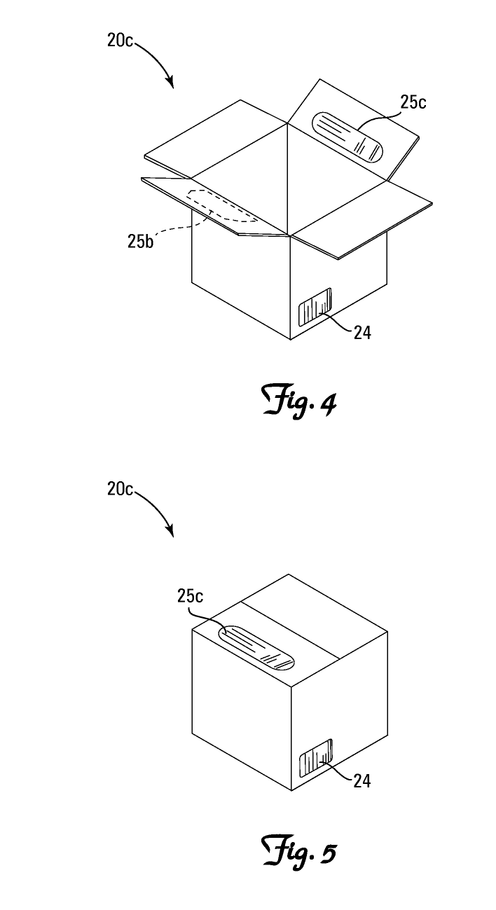

Referring to FIGS. 6 and 7, the delivery and recovery loop designated a depicts a delivery and recovery loop that involves a single management facility 100, a single and separate distribution facility 200₁, and a single customer facility 300₁. The depicted delivery and recovery loop a utilizes the services of (i) a transfer courier 150₁ to transfer thermally conditioned shipping containers 20a, as depicted in FIG. 2, from the management facility 100 to the distribution facility 200₁ in accordance with the transfer label 25a placed by the management facility 100 on the shipping containers 20a, (ii) a delivery courier 250₁ to deliver loaded shipping containers 20b, as depicted in FIG. 3, from the distribution facility 200₁ to the customer facility 300₁ in accordance with the delivery label 25b placed by the distribution facility 200₁ on the shipping containers 20b, and (iii) a return courier 350₁ to return empty shipping containers 20c, as depicted in FIGS. 4 (emptied) and 5 (return labeled), from the customer facility 300₁ to the management facility 100 in accordance with the return label 25c on the empty shipping containers 20c, which label was placed inside the shipping container 20 by the management facility 100 when it originally left the management facility 100.

The transfer 150₁, delivery 250₁ and return 350₁ couriers may be the same or different couriers. Generally, the transfer courier 150₁ and the return courier 350₁ will be selected by the management facility 100, while the delivery courier 250₁ will be selected by the distribution facility 200₁.

Referring to FIG. 6, the delivery and recovery loop designated β depicts a delivery and recovery loop that involves a single management facility 100, a single and separate distribution facility 200₂ and multiple customer facilities 300₂ₐ and 300_{2b}. The depicted delivery and recovery loop β utilizes the services of (i) a transfer courier 150₂ to transfer thermally conditioned shipping containers 20a, as depicted in FIG. 2, from the management facility 100 to the distribution facility 200₂ in accordance with the transfer label 25a placed by the management facility 100 on the shipping containers 20a, (ii) a delivery courier 250₂ to deliver loaded shipping containers 20b, as depicted in FIG. 3, from the distribution facility 200₁ to a first customer facility 300₂ₐ and a second customer facility 300_{2b} in accordance with the delivery label 25b placed by the distribution facility 200₁ on the shipping containers 20b, and (iii) a return courier 350₂ to return empty shipping containers 20c, as depicted in FIGS. 4 (emptied) and 5 (return labeled), from both the first and second customer facilities 300₂ₐ and 300_{2b} to the management facility 100 in accordance with the return label 25c on the empty shipping containers 20c, which label was placed inside the shipping container 20 by the management facility 100 when it originally left the management facility 100.

The transfer 150₂, delivery 250₂ and return 350₂ couriers may be the same or different couriers. Generally, the transfer courier 150₂ and the return courier 350₂ will be selected by the management facility 100, while the delivery courier 250₂ will be selected by the distribution facility 200₁. Similarly, the return couriers 350₂ used to return empty shipping containers 20c from each of the customer facilities 300₂ₐ and 300_{2b} may be the same or different couriers.

Referring to FIG. 6, the delivery and recovery loop designated γ depicts a delivery and recovery loop that involves a single integrated management facility 100 and distribution facility 200₃, and a single customer facility 300₃. Since the management facility 100 and distribution facility 200₃ are integrated at a single facility, the depicted delivery and recovery loop γ only utilizes the services of (i) a delivery courier 250₃ to deliver loaded shipping containers 20b, as depicted in FIG. 3, from the distribution facility 200₃ to the customer facility 300₃ in accordance with the delivery label 25b placed by the distribution facility 200₃ on the shipping containers 20b, and (ii) a return courier 350₃ to return empty shipping containers 20c, as depicted in FIGS. 4 (emptied) and 5 (return labeled), from the customer facility 300₃ to the management facility 100 in accordance with the return label 25c on the empty shipping containers 20c, which label was placed inside the shipping container 20 by either the management facility 100 or the distribution facility 200₃ when it originally left the integrated management facility 100 and distribution facility 200₃.

The delivery 250₃ and return 350₃ couriers may be the same or different couriers. Generally, both of the delivery 250₃ and return 350₃ couriers will be selected by the integrated management facility 100 and distribution facility 200₃.

The logistics system 10 can also accommodate additional intermediate stops along a delivery and recovery loop, such as a shipping and receiving dispersal facility (not shown) which receives thermally conditioned shipping containers 20a from a single management facility 100 and disperses the thermally conditioned shipping containers 20a to multiple distribution facilities 200, or a shipping and receiving collection facility (not shown) which receives empty shipping containers 20c from multiple customer facilities 300 and coordinates return of the empty shipping containers 20c to the management facility 100. Any such intermediate stop needs to perform as and interact with the computer network server 90 as a distribution facility 200.

Delivery and recovery loops α, β and γ depict return of the empty shipping containers 20c to the management facility 100 from whence the shipping container 20 originated. Alternatively, a plurality of management facilities 100 may cooperate in management of returned empty shipping containers 20c by simply integrating their inventory and data capture. This would allow return of empty shipping containers 20c to the closest management facility 100, with physical inventory at each management facilities 100 monitored by the computer network server 90 and an inventory reallocation signal generated as necessary when the number of shipping containers 20 located at one management facility 100 falls below a minimum threshold value while the number of shipping containers 20 located at another management facility 100 exceeds a maximum threshold value.

### Data Input

Each management facility 100, distribution facility 200, customer facility 300, transfer courier 150, delivery courier 250 and return courier 350 need to input or permit downloading of the information set forth in Table One below, into the database on the computer network server 90, with all information correlated directly or through a tracking number to the identification number 24 of the shipping container 20.

TABLE ONE

| | SHIPPING CONTAINER INFORMATION | |
|---|---|---|
| ENTITY | INCOMING | OUTGOING |
| Management | Receipt Date | RETURN LABEL: |
| Facility 100 | | Tracking No. |
| | | Receiving Address |
| | | TRANSFER LABEL: |
| | | Tracking No. |
| | | Receiving Address |
| | | Sent Date |
| Transfer Courier | Transfer Label Tracking No. | Delivered Date |
| 150 | Receipt Date | |
| Distribution | Receipt Date | DELIVERY LABEL: |
| Facility 200 | | Tracking No. |
| | | Receiving Address |
| | | Sent Date |
| Delivery Courier | Delivery Label Tracking No. | Delivered Date |
| 250 | Receipt Date | |
| Customer Facility | Receipt Date | Sent Date |
| 300 | | |
| Return Courier | Return Label Tracking No. | Delivered Date |
| 350 | Receipt Date | |

The dual entry of tracking nos. by the sending facility and the courier (e.g., transfer label 25a tracking number entered by both the management facility 100 and the transfer courier 150, delivery label 25b tracking number entered by both the distribution facility 200 and the delivery courier 250, and return label 25c tracking number entered by both the management facility 100 and the return courier 350) is not required, but such redundancy can serve to confirm accuracy of previously entered information. Similarly, the mimicking paired entry of both a delivered date and a received date each time a given shipping container 20 arrives at its destination (e.g., the date a thermally conditioned shipping container 20a is delivered by a transfer courier 150 and received by a distribution facility 200, the date a loaded shipping container 20b is delivered by a delivery courier 250 and received by a customer facility 300, and the date an empty shipping container 20c is delivered by a return courier 350 and received by a management facility 100,) is not required, but such redundancy can serve to confirm accuracy of previously entered information.

One of the benefits of this logistics system 10 and method is that it does not require the customer facility 300 to input of any information or even interact in any way with the computer network system 90. Customers tend to be the weak link in the chain as they have little or no interest in the shipping container 20 once the thermally labile payload 30 has been removed from the retention chamber 29 of the shipping container 20, and therefore do not consistently or reliably participate in efforts to return empty shipping containers 20c to a management facility 100. Since the information which a customer facility 300 would input into the computer network system 90 (a receipt data and a sent date) mimics information that the delivery courier 250 (a delivered date) and the return courier 350 (a receipt date) already provide, the logistics system 10 and method can operate without active participation by the customer facility 300 beyond retention of the empty shipping containers 20c for a brief period of time.

### Reports

The correlated information and data contained in the database on the computer network system 90 permits a wide range of action statistics and corresponding reports to be generated and displayed on one or more of management facility computers 110, distribution facility computers 210, customer facility computers 310, transfer courier computers 160, delivery courier computers 260, and/or return courier computers 360. Generally, the management facility 100 and the distribution facility 200 are the only participants that will both input or download data into the database on the computer network system 90 and obtain or receive action statistics and corresponding reports from the computer network system 90. The transfer courier 150, delivery courier 250 and return courier 350 will generally only input or download data into the database, while the customer facility 300 will interact with the computer network system 90 only to request a pick-up of empty shipping containers 20c, if at all.

Depending upon the operating procedures of the management facility 100 and the distribution facility 200, as well as the time sensitive nature of the action statistic and corresponding report, the reports can be generated and displayed automatically or only upon request.

A nonexhaustive listing of exemplary action statistics and corresponding reports include (i) a low inventory signal, triggered by a number of shipping containers 20 in inventory below a threshold value, (ii) an expired container signal, triggered by a thermally conditioned shipping container 20a located at a distribution facility 200 for longer than a threshold time period without use of the shipping container 20a to deliver a payload 30, (iii) a forgotten container signal, triggered by a shipping container 20c located at a customer facility 300 for longer than a threshold time period, and (iv) a stockpile signal, triggered by a number of shipping containers 20c located at a customer facility 300 in excess of a given threshold value.

1-14. (canceled)

15. A delivery and recovery shipping logistics system for passive thermal control shipping containers, the system comprising a computer and being configured to:
(a) receive, by the computer, inventory data indicating an inventory of shipping containers managed by a first facility, the inventory data including a unique identifier for each shipping container in the inventory;
(b) receive, by the computer, shipment and location data associated with each shipping container, the shipment and location data associated with each shipping container being correlated with the unique identifier of the associated shipping container, the shipment and location data including at least (i) an identification of a most recent delivery destination of the shipping container as between an identification of a management facility, an identification of a distribution facility and an identification of a customer facility, and (ii) at least one of sent date, delivered date and receipt date of the shipping container at the most recent delivery destination; and
(c) generate, by the computer, a report including at least one action statistic derived at least in part from the received shipment and location data for the shipping containers in the inventory.

16. A system as recited in claim 15, wherein the first facility is a management facility, the passive thermal control shipping containers include a phase change material panel capable of controlling the temperature within the container for a limited time period when thermally conditioned, and the at least one action statistic is selected from the group consisting of (i) a low inventory signal, triggered by a number of shipping containers in inventory being below a predefined threshold value, (ii) an expired container signal, triggered by a thermally conditioned shipping container located at a distribution facility for longer than a threshold time period without use of the thermally conditioned shipping container to deliver a payload, (iii) a forgotten container signal, triggered by a shipping container located at a customer facility for longer than a predefined threshold time period, and (iv) a stockpile signal, triggered by a number of shipping containers located at a customer facility in excess of a given threshold value.

17. A system as recited in claim 15, wherein the inventory data includes shipping container loss or disposal data, the system further configured to decrement from an inventory number, a number of shipping containers corresponding to a number of shipping containers lost or disposed.

18. A system as recited in claim 15 wherein the system is further configured receive tracking data generated by a third party carrier for each shipped shipping container that includes at least (i) a unique tracking number employed by the third party carrier to identify the shipped shipping container, (ii) identification of a delivery destination, and (iii) a delivered date.

19. A system as recited in claim 18, wherein the tracking data is received by downloading the tracking data from a computer associated with the third party carrier.

20. A delivery and recovery shipping logistics system for a plurality of passive thermal control shipping containers configured to be thermally conditioned to contain a thermally labile payload, the system comprising a computer and is configured to:
(a) receive, by the computer, a delivery tracking number and a delivery address read from a delivery label on and associated with each respective one of the shipping containers, the delivery address identifying an address to which the shipping container associated with the label is to be delivered after being thermally conditioned and while containing the thermally labile payload, the delivery tracking number and delivery address being correlated with a unique identifier associated with the shipping container;
(b) receive, by the computer, at least one of a sent date, delivered date, or receipt date for at least one of the shipping containers containing the thermally labile payload, the at least one sent date, delivered date or receipt date for the at least one shipping container containing the thermally labile payload being correlated with the identification code associated with the at least one shipping container;
(c) receive, by the computer, a return tracking number read from a return label on and associated with each respective one of the shipping containers, the return tracking number being associated with a facility to which the shipping container associated with the return label is to be delivered after the thermally labile payload has been removed from the shipping container, the return tracking number being correlated with a unique identifier associated with the shipping container;
(d) receive, by the computer, at least one of a sent date, delivered date, or receipt date for at least one of the shipping containers that is free of the thermally labile payload, the at least one sent date, delivered date or receipt date for the at least one shipping container free of the thermally labile payload being correlated with the identification code associated with the at least one shipping container;
(e) generate a report including at least one action statistic based, at least in part, on at least one of the sent date, delivered date or receipt date for the at least one of the shipping containers containing the thermally labile payload, or for the at least one of the shipping containers free of the thermally labile payload.

21. A system as recited in claim 20, further configured to:
(a) receive, by the computer, a transfer tracking number and a transfer address read from a transfer label on and associated with each respective one of the shipping containers, the transfer address identifying an address to which the shipping container associated with the label is to be delivered after being thermally conditioned and from which the thermally conditioned shipping container containing the thermally labile payload is to be shipped to the delivery address read from the delivery label associated with the shipping container, the transfer tracking number and transfer address being correlated with a unique identifier associated with the shipping container;
(b) receive, by the computer, at least one of a sent date, delivered date, or receipt date for at least one of the shipping containers after being thermally conditioned, the at least one sent date, delivered date or receipt date for the at least one thermally conditioned shipping container being correlated with the identification code associated with the at least one shipping container;
(c) generate a report including at least one action statistic based, at least in part, on at least one of the sent date, delivered date or receipt date for the at least one of the thermally conditioned shipping containers.

22. A system as recited in claim 20, further including a plurality of shipping containers, including the return label and the delivery label associated with each shipping container, the return label being arranged on an exterior surface of an associated shipping container, the return label being arranged on an interior surface of the associated shipping container.

23. A system as recited in claim 20, wherein the computer receives the at least one of a sent date, delivered date, or receipt date for the shipping container containing the thermally labile payload from a further computer at a first facility, and wherein the computer receives the at least one of a sent date, delivered date and receipt date for the shipping container that is free of the thermally labile payload from another further computer at a second facility, the second facility being different from the first facility.

24. A system as recited in claim 20, wherein the at least one action statistic is selected from the group consisting of (i) a low inventory signal, triggered by a number of shipping containers in an inventory being below a predefined threshold value, (ii) an expired container signal, triggered by a thermally conditioned shipping container located at a distribution facility for longer than a threshold time period without use of the thermally conditioned shipping container to deliver a payload, (iii) a forgotten container signal, triggered by a shipping container located at a customer facility for longer than a predefined threshold time period, and (iv) a stockpile signal, triggered by a number of shipping containers located at a customer facility in excess of a given threshold value.

25. A delivery and recovery shipping logistics method for a plurality of passive thermal control shipping containers configured to be thermally conditioned to contain a thermally labile payload, the method comprising:
(a) receiving, by a computer, a delivery tracking number and a delivery address read from a delivery label on and associated with each respective one of the shipping containers, the delivery address identifying an address to which the shipping container associated with the label is to be delivered after being thermally conditioned and while containing the thermally labile payload, the delivery tracking number and delivery address being correlated with a unique identifier associated with the shipping container;
(b) receiving, by the computer, at least one of a sent date, delivered date, or receipt date for at least one of the shipping containers containing the thermally labile payload, the at least one sent date, delivered date or receipt date for the at least one shipping container containing the thermally labile payload being correlated with the identification code associated with the at least one shipping container;
(c) receiving, by the computer, a return tracking number read from a return label on and associated with each respective one of the shipping containers, the return tracking number being associated with a facility to which the shipping container associated with the return label is to be delivered after the thermally labile payload has been removed from the shipping container, the return tracking number being correlated with a unique identifier associated with the shipping container;
(d) receiving, by the computer, at least one of a sent date, delivered date, or receipt date for at least one of the shipping containers that is free of the thermally labile payload, the at least one sent date, delivered date or receipt date for the at least one shipping container free of the thermally labile payload being correlated with the identification code associated with the at least one shipping container;
(e) generating a report including at least one action statistic based, at least in part, on at least one of the sent date, delivered date or receipt date for the at least one of the shipping containers containing the thermally labile payload, or for the at least one of the shipping containers free of the thermally labile payload.

26. A method as recited in claim 25, further comprising:
(a) thermally conditioning at least one first shipping container of the plurality of shipping containers;
(b) placing a thermally labile payload into each first shipping container;
(c) applying a return label on each first shipping container, the return label bearing a return tracking number and a receiving address;
(d) applying a delivery label on each first shipping container, the delivery label bearing a delivery address to which the thermally labile payload is to be delivered;
(e) shipping each first shipping container to a first facility corresponding to the receiving address, after the computer receives the delivery tracking number and the delivery address read from the delivery label on each first shipping container;
(f) receiving, by the computer, at least one of a sent date, delivered date, or receipt date for at least one first shipping container containing the thermally labile payload, upon or after shipping the at least one first shipping container to the first facility;
(g) shipping at least one first shipping container that is free of the thermally labile payload from the first facility to a second facility, after the thermally labile payload has been unloaded from the at least one first shipping container; and
(h) receiving, by the computer at least one of a sent date, delivered date, or receipt date for the at least one first shipping container that is free of the thermally labile payload, upon or after shipping the at least one first shipping container from the first facility to the second facility.
